(19) United States
(12) Patent Application Publication
(10) Pub. No.: US 2001/0032770 A1
(43) Pub. Date: Oct. 25, 2001

(54) Transmission for a vehicle with a hydro-dynamical retarder

(76) Inventor: Bernd Fessler, Kressbronn (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/853,138

(22) Filed: May 10, 2001

(30) Foreign Application Priority Data
Jun. 2, 2000 (DE) 100 27 376.9

(51) Int. Cl. B60K 41/26

(52) U.S. Cl. 192/216; 188/266

(57) ABSTRACT

The invention is based on a vehicle transmission with a hydrodynamic retarder (1), the stator (3) of which is supported on a transmission housing (2) and the rotor of which is coupled with the vehicle input drive part of the transmission. The proposal is, that the stator (1) be pivotally anchored in the transmission housing (2) to rotate about the axis of rotation (17) of the rotor within a limited angular area. Further that said stator (1) is supported on at least one spring element (5, 6) on the transmission housing (2), whereby at least one spring element (6) acts upon a regulating piston (8) of the pressure regulation valve (7).

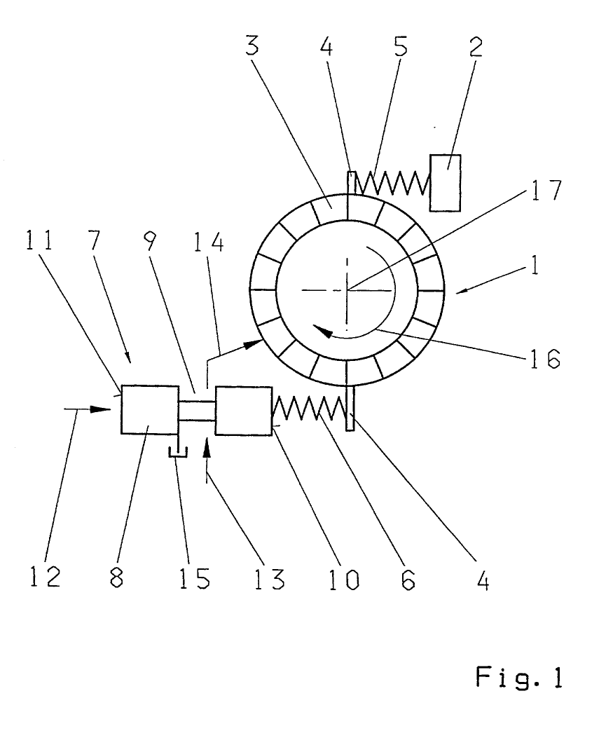

The invention concerns a vehicle transmission with a hydrodynamic retarder in accord with the generic concept of claim 1.

In the case of busses and commercial vehicles, frequently automatic transmissions with an integrated retarder are installed. These are placed on the input side of the vehicle transmission as a primary retarder or they a placed on the output side as a secondary retarder. Retarders are comprised principally of a rotor and a stator. While the stator is affixed to the transmission housing, that is to say, it is a part of the transmission housing, the rotor is connected to the output drive during retarder braking, when a secondary retarder is concerned. The speed of rotation of the rotor is consequently dependent upon the driving speed of the vehicle.

If the retarder, serving as a primary retarder, is connected with the input drive of the vehicle transmission, then the speed of rotation of the rotor, besides being dependent upon the driving speed of the vehicle, is also dependent of the gear ratio of the current gear stage in which the vehicle is being driven.

The stator transfers the active braking moment to the transmission housing.

This moment changes with the variable magnitudes of the pertinent forces, namely the rotor RPM, the temperature, the viscosity and the pressure of the hydraulic medium in the retarder space. Under the conditions inherent in the behavior of a fluid operated machine, which the retarder is, substantial deviations from the desired braking moment arise, which in part are due to the influence of blading and the pressure control at the retarder inlet and outlet.

Thus, the invention has the purpose of bringing the braking moment of the retarder to a more precise adjustment and provide greater stability in its function. This purpose is achieved by the features of claim 1. Further embodiments become evident in the subordinate claims.

In accord with the invention, the stator is pivotally anchored in the transmission housing with freedom to pivot within a limited angle about the same axis as the rotor. The stator supports itself at least on one spring element on said transmission housing. At least one spring element acts upon a control piston of a pressure regulating valve. All springs and elastic elements which possess appropriate control characteristics are suitable to be used as such spring elements.

During the braking process, the rotor generates a braking moment, which is transmitted from the stator onto the spring element, so that the control piston of the pressure control valve directly receives information in regard to the magnitude of the said braking movement and thus can maintain a constant and exact braking moment in accord with the specifications. This is more advantageous, than employing the inside pressure as a regulating pressure of suitable control magnitude, since the retarder interior pressure does not take into consideration other remaining variable influences on the braking moment.

In an advantageous manner, the control piston possesses a pressure equalizing control groove, by means of which the hydraulic medium is conducted to the retarder, or taken away therefrom. One of its end surfaces is loaded by the force of a spring element, which serves as a regulating spring. On the other end surface, a control pressure and/or a control force is exerted, by means of which, the desired braking moment is brought about. Further, it is of advantage that the rate of rotation of the rotor is kept linear to the braking moment.

In order to be able to keep the braking function of the retarder at an optimum level on a respective vehicle, relative to size and weight, it is proposed in another embodiment, that the control valve be such as can balance the demands of the current maximum braking moment. Besides its control duties, the control valve can also be employed to make a quick refill of the retarder.

Further advantages are made evident by the following description with the aid of the drawing. In this drawing, an embodiment of the invention is presented. The description and the claims contain numerous features in combination. The expert can observe the said features individually, and combine these to even further advantageous combinations.

The single FIGURE is a schematic sketch of a retarder, with only such detail as is necessary for the understanding of the present discovery.

Only a stator 3 of a complete retarder 1 is shown, while a rotor, which rotates about an axis of rotation 17 in the direction 16, is not shown in further detail. The stator 3 is anchored in a transmission housing with the ability to pivot through a limited angle about the rotation axis 17. The stator 3 supports itself in the direction of rotation 16 by supports 4, which are provided on its circumference. From supports 4, the stator is sequentially supported by spring elements 5 and 6, which are anchored on the transmission housing 2. Although the spring element 5 supports itself directly on the said housing 2, the spring element 6 acts against an end surface 10 of a control piston 8 of a control valve 7, the housing of which is not detailed, but is contained within the transmission housing 2.

On an end surface 11 of the control piston 8, the other end being designated 10, acts a control force 12, or a corresponding pre-control pressure. By means of this control force 12, the control piston 8 is pushed, more or less axially, counter to the force of the spring element 6, so that a specified braking moment can be established. At the same time, a pressure compensating control groove 9 of the control piston 8, releases or closes a hydraulic fluid supply 13 as called for by a hydraulic feed 14 of the retarder 1. The surplus delivered quantity of the hydraulic fluid is directed to an oil sump.

By means of a pressure increase in the retarder 1, the braking moment also increases, so that the force of the spring element 6 increases itself. Spring element 6 thereupon forces the control piston 8 counter to the control force 12, until an equilibrium has been brought about. When this equilibrium has been established, the braking moment corresponds to the force exerted by the control force 12. Should the braking moment of the retarder I be reduced, then the control groove 9 once again opens the hydraulic fluid supply 13 further, so that the pressure in the retarder climbs and the braking moment can be held constant over a wide range. Should the braking moment exceed the set threshold amount, then the control groove 9 closes the hydraulic fluid supply and the pressure in the interior chamber of the retarder falls, so that the braking movement can be brought back to the desired amount.

In the illustrated embodiment, the control valve controls the input flow into the interior of the retarder 1. At the start of the braking function, the control valve 7 can also serve for the quick filling of the retarder 7, before it takes over the control of the brake moment.

### REFERENCE NUMERALS

1 retarder]

2 transmission housing

3 stator

4 support

5 spring element

6 spring element

7 control valve

8 control piston

9 control groove

10 end surface

11 end surface

12 control force

13 hydraulic fluid feed

14 pressure application

15 oil sump

16 direction fo rotation

17 axis of rotation

1. A vehicle transmission with a hydrodynamic retarder (1), the stator (3) of which is supported on the transmission housing (2) and the rotor of which is coupled with the input part of the vehicle transmission, therein characterized, in that the stator (1) is pivotally anchored in the transmission housing (2) to rotate about an axis of rotation (17) of the rotor through a limited angle of movement and supports itself at least on one spring element (5, 6) on the transmission housing (2), wherein at least one spring element (6) acts on a control piston (8) of a pressure regulating valve (7).

2. A vehicle transmission in accord with claim 1, therein characterized, in that the control piston (8) possesses a pressure equalizing control groove (9) and one end surface (10) of the control piston (8) is loaded by the spring force of the spring element (6) and the opposite end surface (11) of the control piston (8) is acted upon by a control pressure and/or a control force.

3. A vehicle transmission in accord with one of the foregoing claims, therein characterized, in that the speed of rotation of the rotor is kept linear to the braking moment.

4. A vehicle transmission in accord with one of the foregoing claims, therein characterized, in that the control valve (7) can be equalized.

5. A vehicle transmission in accord with one of the foregoing claims, therein characterized, in that the control valve (7) can serve simultaneously for a quick filling of the retarder (1)
